(19) United States
(12) Patent Application Publication
(10) Pub. No.: US 2014/0051293 A1
(43) Pub. Date: Feb. 20, 2014

(54) MALE CONNECTOR AND FEMALE CONNECTOR FOR TUNER

(71) Applicant: HON HAI PRECISION INDUSTRY CO., LTD., New Taipei (TW)

(72) Inventor: Wei-Ching CHIEN, New Taipei (TW)

(21) Appl. No.: 13/928,780

(22) Filed: Jun. 27, 2013

(30) Foreign Application Priority Data
Aug. 16, 2012 (TW) 101129740

(51) Int. Cl. H01R 13/66

(52) U.S. Cl. CPC H01R 13/665
USPC 439/620.21

(57) ABSTRACT

A male connector is connected to a tuner and is dimensioned in accordance with a standard video graphics array (VGA) male connector. The male connector includes a red video male pin, a green video male pin, a blue video male pin, an inter-integrated circuit (I2C) data, and an I2C clock male pin. The red video male pin receives a left channel audio signal from the tuner. The green video male pin receives a right channel audio signal from the tuner. The blue video male pin receives a video signal from the tuner. The I2C data male pin transmits an I2C data signal to the tuner, the I2C clock male pin transmits an I2C clock signal to the tuner, the I2C data signal and the I2C clock signal control the tuner to select one of the television radio frequency signals.

### BACKGROUND

1. Technical Field

The disclosed embodiments relate to connectors, and particularly, to a male connector and a female connector for a tuner.

2. Description of Related Art

Many personal computers use the same type of 15 pin display connector. Because that connector was used in the original IBM VGA card, it is often referred to simply as a standard VGA connector. The standard VGA connector is only used to transmit video signals to the display, thus the display displays images according to the video signals. However, the above standard VGA connector cannot be used for transmitting audio signals.

Therefore, there is room for improvement in the art.

### BRIEF DESCRIPTION OF THE DRAWINGS

Many aspects of the embodiments can be better understood with reference to the drawing. The components in the drawing are not necessarily drawn to scale, the emphasis instead being placed upon clearly illustrating the principles of the present embodiments. Moreover, in the drawings, like reference numerals designate corresponding parts throughout six views.

FIG. 1 is a schematic diagram showing a male connector in accordance with a first embodiment.

FIG. 2 is a schematic diagram showing a male connector in accordance with a second embodiment.

FIG. 3 is a schematic diagram showing a male connector in accordance with a third embodiment.

FIG. 4 is a schematic diagram showing a female connector in accordance with a first embodiment.

FIG. 5 is a schematic diagram showing a female connector in accordance with a second embodiment.

FIG. 6 is a schematic diagram showing a female connector in accordance with a third embodiment.

### DETAILED DESCRIPTION

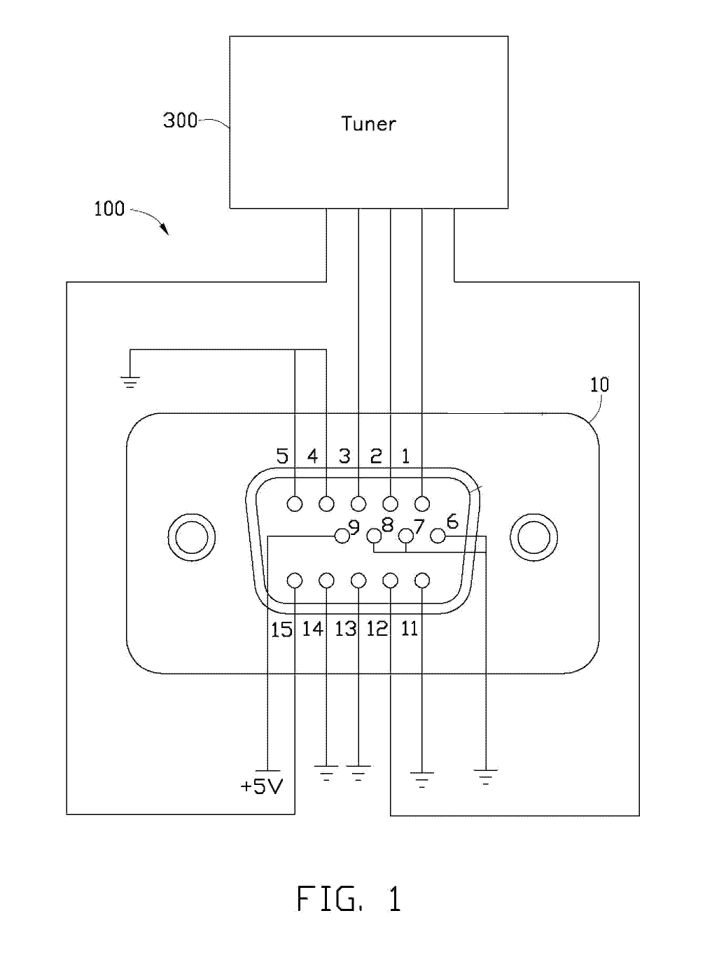

FIG. 1 shows a male connector 100 in accordance with a first embodiment. The male connector 100 is connected to a tuner 300, and the male connector 100 is dimensioned in accordance with a standard video graphics array (VGA) male connector.

The male connector 100 includes a male casing 10, and a red video male pin 1, a green video male pin 2, a blue video male pin 3, a monitor identification (ID) 2 male pin 4, a horizontal synchronization (Hsync) return male pin 5, a red return male pin 6, a green return male pin 7, a blue return male pin 8, a power male pin 9, a monitor ID 0 male pin 11, an inter-integrated circuit (I2C) data male pin 12, a Hsync male pin 13, a vertical synchronization (Vsync) male pin 14, and an I2C clock male pin 15. The male pins 1, 2, 3, 4, 5, 6, 7, 8, 9, 11, 12, 13, 14, 15 are mounted in the male casing 10.

The red video male pin 1, the green video male pin 2, the blue video male pin 3, the I2C data male pin 12, and the I2C clock male pin 15 are connected to the tuner 300. The red video male pin 1 is configured to receive a left channel audio signal from the tuner 300. The green video male pin 2 is configured to receive a right channel audio signal from the tuner 300. The blue video male pin 3 is configured to receive video signals from the tuner 300. The I2C data male pin 12 is configured to transmit an I2C data signal to the tuner 300, the I2C clock male pin 15 is configured to transmit an I2C clock signal to the tuner 300, the I2C data signal and the I2C clock signal control the tuner 300 to select one of the television radio frequency (RF) signals.

The red return male pin 6 is grounded. The green return male pin 7 is grounded. The blue return male pin 8 is grounded. The power male pin 9 receives power from a power source +5V. The monitor ID 0 male pin 11 is grounded. The monitor ID 2 male pin 4 is grounded. The Hsync male pin 13 is grounded. The Vsync male pin 14 is grounded. A Hsyn return male pin 5 is grounded. A Vsync return male pin of the standard VGA male connector is removed from the male connector 100, that is, the Vsync return male pin of the standard VGA male connector is not included in the male connector 100. In other embodiments, a Vsyn return male pin 5 is grounded, a Hsync return male pin of the standard VGA male connector is removed from the male connector 100, that is, the Hsync return male pin of the standard VGA male connector is not included in the male connector 100.

In the male connector 100, the red video male pin 1 and the green video male pin 2 are connected to the tuner 300. The red video male pin 1 receives a left channel audio signal from the tuner 300, and the green video male pin 2 receives a right channel audio signal from the tuner 300, therefore, the male connector 100 can transmit the audio signals. Furthermore, the Vsync return male pin of the standard VGA male connector is not included in the male connector 100, that is, the male connector 100 has total 14 pins, therefore, the male connector 100 that has total 14 pins cannot mate with the standard VGA female connector that has total 15 pins, which prevents the male connector 100 from being mistakenly inserted into the standard VGA female connector.

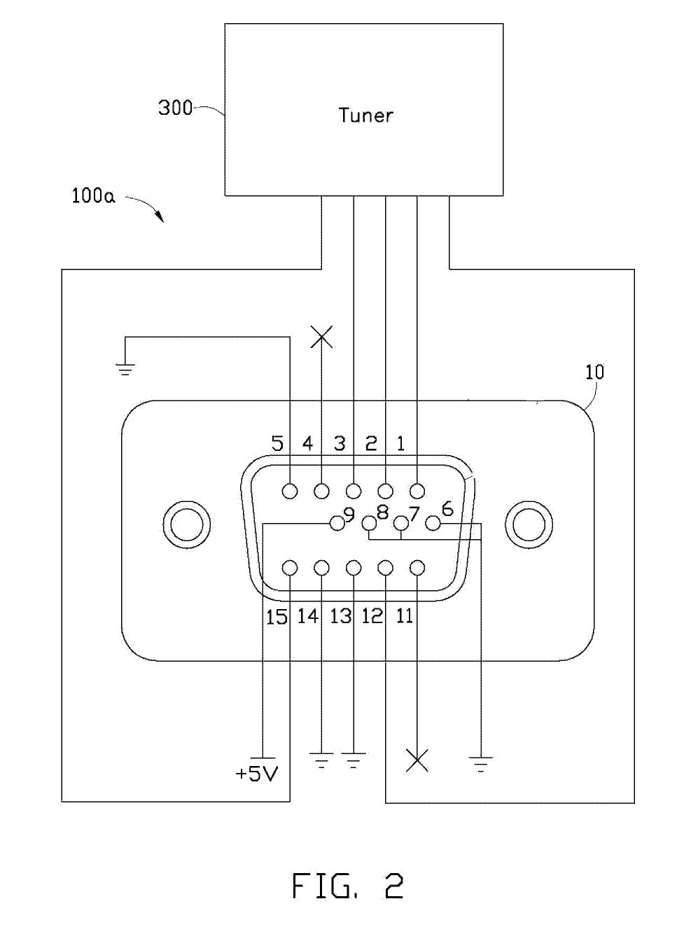

FIG. 2 shows a male connector 100a in accordance with a second embodiment. As a first alternative embodiment of the male connector 100, in the male connector 100a, the monitor ID 0 male pin 11 is floated, the monitor ID 2 male pin 4 is floated; the Hsync male pin 13 is grounded; the Vsync male pin 14 is grounded.

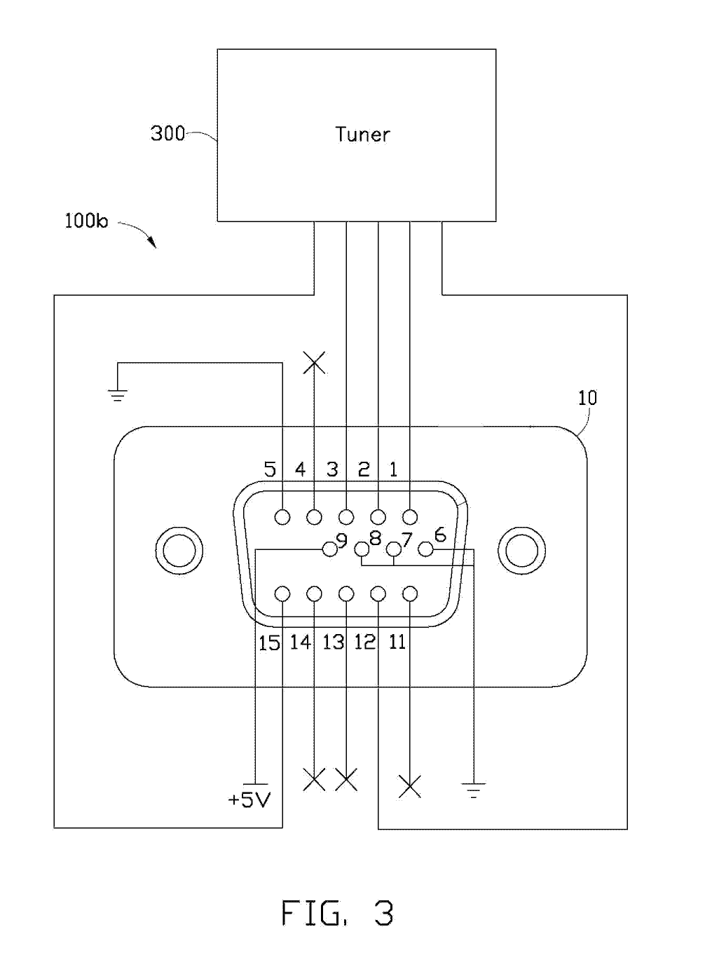

FIG. 3 shows a male connector 100b in accordance with a third embodiment. As a second alternative embodiment of the male connector 100, in the male connector 100b, the monitor ID 0 male pin 11 is floated, the monitor ID 2 male pin 4 is floated; the Hsync male pin 13 is floated; the Vsync male pin 14 is floated.

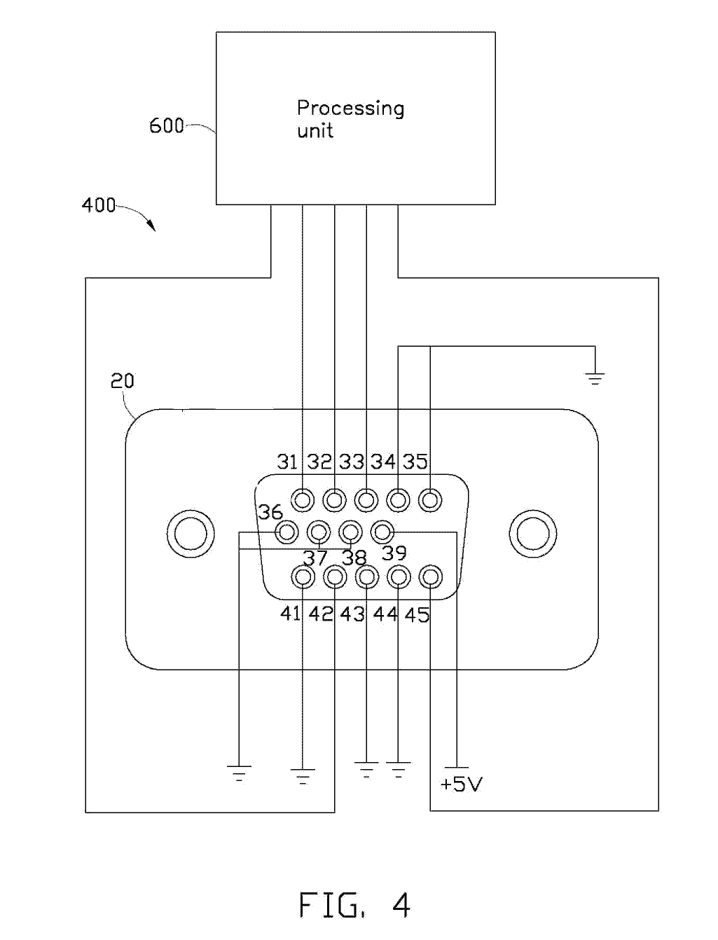

FIG. 4 shows a female connector 400 in accordance with a first embodiment. The female connector 400 mates with the male connector 100 or 100a or 100b. The female connector 400 is connected to the processing unit 600, and the female connector 400 is dimensioned in accordance with a standard VGA female connector.

The female connector 400 includes a female casing 40, and a red video female pin 31, a green video female pin 32, a blue video female pin 33, a monitor ID 2 female pin 34, a Hsync return female pin 35, a red return female pin 36, a green return female pin 37, a blue return female pin 38, a power female pin 39, a monitor ID 0 female pin 41, an I2C data female pin 42, a Hsync female pin 43, a Vsync female pin 44, and an I2C clock female pin 45. The pins 31, 32, 33, 34, 35, 36, 37, 38, 39, 41, 42, 43, 44, 45 are mounted in the female casing 20.

The red video female pin 31, the green video female pin 32, the blue video female pin 33, the I2C data female pin 42, and the I2C clock female pin 45 are connected to the processing unit 600. The red video female pin 31 is configured to transmit the left channel audio signal to the processing unit 600. The green video female pin 32 is configured to transmit the right channel audio signal to the processing unit 600. The blue video female pin 33 is configured to transmit the video signal to the processing unit 600. The I2C data female pin 42 receives an I2C data signal from the processing unit 600. The I2C clock female pin 45 receives an I2C clock signal from the processing unit 600. When the female connector 400 mates with the male connector 100, the I2C data signal and the I2C clock signal are transmitted to the tuner 300 through the female connector 400 and the male connector 100, the I2C data signal and the I2C clock signal control the tuner 300 to select one of the television RF signals; and the left channel audio signal, the right channel audio signal and the video signal are transmitted to the processing unit 600 through the male connector 100 and the female connector 400.

The red return female pin 36 is grounded. The green return female pin 37 is grounded. The blue return female pin 38 is grounded. The power female pin 39 receives power from a power source +5V. The monitor ID 0 female pin 41 is grounded. The monitor ID 2 female pin 34 is grounded. The Hsync female pin 43 is grounded. The Vsync female pin 44 is grounded. A Hsyn return female pin 45 is grounded. A Vsync return female pin of the standard VGA female connector is removed from the female connector 400, that is, the Vsync return female pin of the standard VGA female connector is not included in the female connector 400. In other embodiments, a Vsyn return female pin 45 is grounded, a Hsync return female pin of the standard VGA female connector is removed from the female connector 400, that is, the Hsync return female pin of the standard VGA female connector is not included in the female connector 400.

In the female connector 400, the red video female pin 31 and the green video female pin 32 are connected to the tuner 300. The red video female pin 31 receives a left channel audio signal from the tuner 300, and the green video female pin 32 receives a right channel audio signal from the tuner 300, therefore, the female connector 400 can transmit the audio signals. Furthermore, the Vsync return female pin of the standard VGA male connector is not included in the female connector 400, that is, the female connector 400 has total 14 pins, therefore, the female connector 400 that has total 14 pins cannot mate with the standard VGA male connector that has total 15 pins, which prevents the female connector 400 from being mistakenly inserted into the standard VGA male connector.

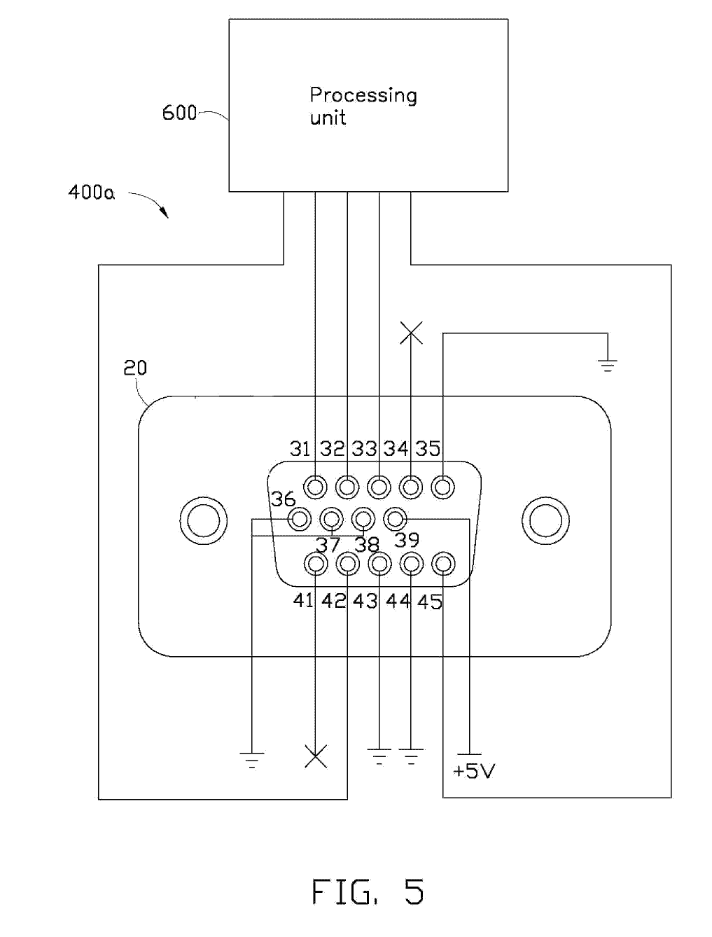

FIG. 5 shows a female connector 400a in accordance with a second embodiment. As a first alternative embodiment of the female connector 400, in the female connector 400a, the monitor ID 0 female pin 41 is floated, the monitor ID 2 female pin 34 is floated; the Hsync female pin 43 is grounded; the Vsync female pin 44 is grounded.

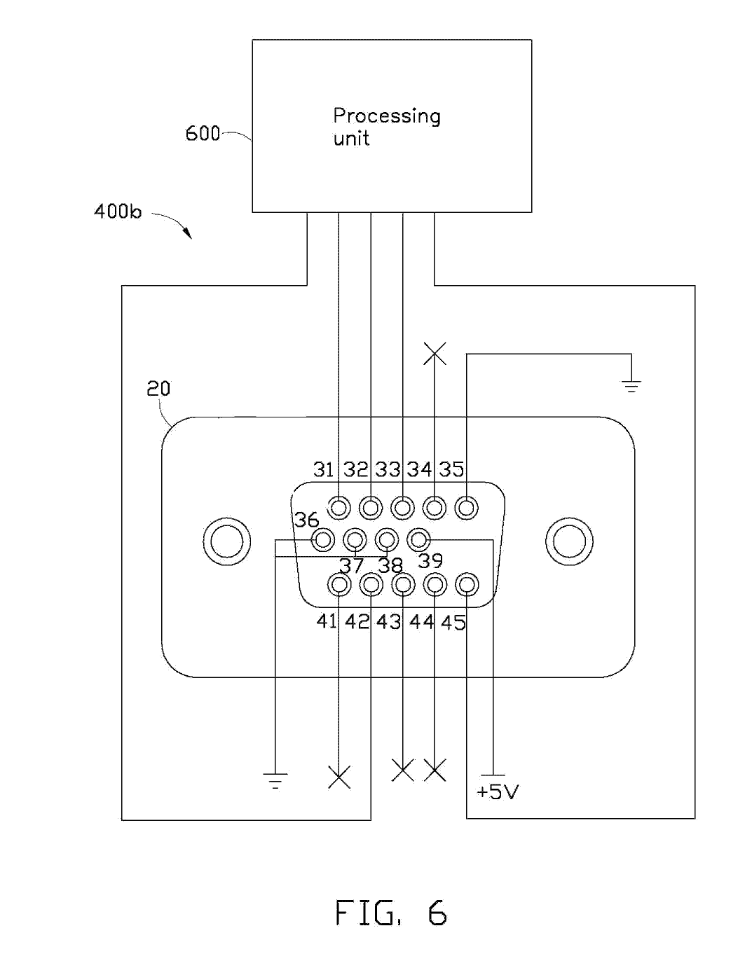

FIG. 6 shows a female connector 400b in accordance with a third embodiment. As a second alternative embodiment of the female connector 400, in the female connector 400b, the monitor ID 0 female pin 41 is floated, the monitor ID 2 female pin 34 is floated; the Hsync female pin 43 is floated; the Vsync female pin 44 is floated.

Alternative embodiments will become apparent to those skilled in the art without departing from the spirit and scope of what is claimed. Accordingly, the present disclosure should not be deemed to be limited to the above detailed description, but rather only by the claims that follow and the equivalents thereof.

1. A male connector being connected to a tuner and being dimensioned in accordance with a standard video graphics array (VGA) male connector, the male connector comprising:
a red video male pin configured to receive a left channel audio signal from the tuner;
a green video male pin configured to receive a right channel audio signal from the tuner;
a blue video male pin configured to receive a video signal from the tuner;
an inter-integrated circuit (I2C) data male pin connected to the tuner; and
an I2C clock male pin connected to the tuner;
wherein the I2C data male pin is configured to transmit an I2C data signal to the tuner, the I2C clock male pin is configured to transmit an I2C clock signal to the tuner, the I2C data signal and the I2C clock signal control the tuner to select one of the television radio frequency (RF) signals.

2. The male connector of claim 1, further comprising:
a red return male pin configured to be grounded;
a green return male pin configured to be grounded; and
a blue return male pin configured to be grounded.

3. The male connector of claim 2, further comprising:
a monitor identification (ID) 0 male pin configured to be floated;
a monitor ID 2 male pin configured to be floated;
a horizontal synchronization (Hsync) male pin configured to be floated; and
a vertical synchronization (Vsync) male pin configured to be floated.

4. The male connector of claim 2, further comprising:
a monitor ID 0 male pin configured to be grounded;
a monitor ID 2 male pin configured to be grounded;
a Hsync male pin configured to be grounded; and
a Vsync male pin configured to be grounded.

5. The male connector of claim 2, further comprising:
a monitor ID 0 male pin configured to be floated;
a monitor ID 2 male pin configured to be floated;
a Hsync male pin configured to be grounded; and
a Vsync male pin configured to be grounded.

6. The male connector of claim 1, further comprising:
a power male pin configured to receive power from a power source;
wherein the male connector further comprises a Hsyn return male pin configured to be grounded; and a Vsync return male pin is not included in the male connector;
or wherein the male connector further comprises the Vsync return male pin configured to be grounded; and the Hsyn return male pin is not included in the male connector.

7. A female connector being connected to a processing unit and being dimensioned in accordance with a standard video graphics array (VGA) female connector, the female connector comprising:
a red video female pin configured to transmit a left channel audio signal to the processing unit;
a green video female pin configured to transmit a right channel audio signal to the processing unit;
a blue video female pin configured to transmit a video signal to the processing unit;
an I2C data female pin connected to the processing unit for receiving an I2C data signal from the processing unit; and
an I2C clock female pin connected to the processing unit for receiving an I2C clock signal from the processing unit.

8. The female connector of claim 7, further comprising:
a red return female pin configured to be grounded;
a green return female pin configured to be grounded; and
a blue return female pin configured to be grounded.

9. The female connector of claim 8, further comprising:
a monitor ID 0 female pin configured to be floated;
a monitor ID 2 female pin configured to be floated;
a Hsync female pin configured to be floated; and
a Vsync female pin configured to be floated.

10. The female connector of claim 8, further comprising:
a monitor ID 0 female pin configured to be grounded;
a monitor ID 2 female pin configured to be grounded;
a Hsync female pin configured to be grounded; and
a Vsync female pin configured to be grounded.

11. The female connector of claim 8, further comprising:
a monitor ID 0 female pin configured to be floated;
a monitor ID 2 female pin configured to be floated;
a Hsync female pin configured to be grounded; and
a Vsync female pin configured to be grounded.

12. The female connector of claim 7, further comprising:
a power female pin configured to receive power from a power source;
wherein the female connector further comprises a Hsyn return female pin configured to be grounded; and a Vsync return female pin is not included in the female connector;
or wherein the male connector further comprises the Vsync return female pin configured to be grounded; and the Hsyn return female pin is not included in the female connector.

13. The female connector of claim 7, wherein an external television RF signal are demultiplexed into the left channel audio signal, the right channel, and the audio signal video signal.

14. A male connector being dimensioned in accordance with a standard VGA male connector, the male connector comprising:
a monitor ID 0 male pin configured to be floated;
a monitor ID 2 male pin configured to be floated;
or the monitor ID 0 male pin configured to be floated and the monitor ID 2 male pin configured to be grounded; or the monitor ID 0 male pin configured to be grounded and the monitor ID 2 male pin configured to be grounded; or the monitor ID 0 male pin configured to be grounded and the monitor ID 2 male pin configured to be floated;
a Hsync male pin configured to be floated; and
a Vsync male pin configured to be floated; or the Hsync male pin configured to be floated and the Vsync male pin configured to be grounded; or the Hsync male pin configured to be grounded and the Vsync male pin configured to be grounded; or the Hsync male pin configured to be grounded and the Vsync male pin configured to be floated;
wherein the male connector further comprises a Hsyn return male pin configured to be grounded; and a Vsync return male pin is not included in the male connector;
or wherein the male connector further comprises the Vsync return male pin configured to be grounded; and the Hsyn return male pin is not included in the male connector.

15. The male connector of claim 14, wherein the male connector is connected to a tuner, the male connector further comprises:
a red video male pin configured to receive a left channel audio signal from the tuner;
a green video male pin configured to receive a right channel audio signal from the tuner;
a blue video male pin configured to receive video signals from the tuner;
an I2C data male pin connected to the tuner; and
an I2C clock male pin connected to the tuner;
wherein the I2C data male pin and the I2C clock male pin are configured to transmit an I2C control signal to the tuner, the I2C control signal controls the tuner to select one of the television RF signals.

16. The male connector of claim 15, further comprising:
a red return male pin configured to be grounded;
a green return male pin configured to be grounded; and
a blue return male pin configured to be grounded.

17. The male connector of claim 16, further comprising:
a power male pin configured to receive power from a power source.
